(19) United States
(12) Patent Application Publication
(10) Pub. No.: US 2014/0315109 A1
(43) Pub. Date: Oct. 23, 2014

(54) Humidification device, in particular for a fuel cell

(71) Applicant: MANN+HUMMEL GMBH, Ludwigsburg (DE)

(72) Inventors: Michael Harenbrock, Ludwigsburg (DE); Michael Fasold, Auenwald (DE); Steffen Schuetz, Bietigheim-Bissingen (DE); Stephan Niemeyer, Steinheim (DE)

(73) Assignee: MANN+HUMMEL GMBH, Ludwigsburg (DE)

(21) Appl. No.: 14/054,499

(22) Filed: Oct. 15, 2013

(30) Foreign Application Priority Data
Oct. 15, 2012 (DE) 102012020130.3

(51) Int. Cl. H01M 8/04

(52) U.S. Cl. CPC H01M 8/04149
USPC 429/414

(57) ABSTRACT

A humidifier has a moisture exchanger with at least one water-permeable membrane as well as a humidifier device with a moisture reservoir which is positioned in the flow path of the moisture exchanger.

### CROSS REFERENCE TO RELATED APPLICATIONS

This application claims the benefit under 35 USC 119 of German patent application DE 102012020130.3 filed Oct. 15, 2012, the above German patent application is hereby incorporated by reference in its entirety.

### TECHNICAL FIELD

The invention concerns a humidifier, in particular for a fuel cell, according to the preamble of claim 1.

### PRIOR ART

A humidifier for a fuel cell is disclosed in EP 1 261 992 B1. By means of the humidifier the air stream that is supplied to the fuel cell is enriched with moisture. The humidifier has a water vapor-permeable membrane that is clamped between frame parts and has one side subjected to the inflowing exhaust gas stream of the fuel cell which is laden with moisture. The moisture is transferred through the membrane to a second air stream on the opposite side which is supplied as a moisture-laden fresh air stream to the fuel cell.

For a proper function of the fuel cell, a minimum moisture contents of the fuel cell membranes must be ensured. This can be achieved in that the fresh air stream to be supplied to the fuel cell is humidified.

### SUMMARY OF THE INVENTION

The invention has the object to configure with simple measures a humidifier such that a sufficient moisture contents in the air stream is ensured.

This object is solved according to the invention with the features of claim 1. The dependent claims provide expedient further developments.

By means of the humidifier according to the invention, flowing air which is passed through the humidifier can be enriched with moisture. The humidifier is advantageously correlated with a fuel cell whose cathode is supplied with a fresh air stream enriched with moisture.

The humidifier has a moisture exchanger with at least one water-permeable or water vapor-permeable membrane positioned between an inlet air flow path and an exhaust air flow path and through which a higher moisture contents in the exhaust air flow path is transferred to the inlet air flow path.

The humidifier according to the invention has, in addition to the moisture exchanger, also a moisture reservoir which is positioned in a flow path of the moisture exchanger and is capable of releasing moisture into the flow path or absorb it from the latter. The moisture reservoir represents a moisture buffer by means of which the moisture contents in the flow path can be regulated. It is in particular possible to increase by means of the moisture reservoir the moisture contents in the flow path and to adjust it in this way to a minimum value or nominal value that is required, for example, for proper functioning of the fuel cell. In reverse, it is also possible to reduce a high moisture contents in the flow path in that is absorbed in the moisture reservoir moisture so that the moisture contents is reduced to the required nominal value.

By means of the moisture reservoir the application range of the humidifier is enlarged. For example, it is possible, even under unfavorable external conditions, for example, in case of frost, to increase the air moisture within the flow path by means of the moisture reservoir and to adjust it to the nominal value.

In principle, different moisture storage media are conceivable for the moisture reservoir. According to a preferred embodiment, a superabsorbent material is provided as a moisture storage medium that is capable of absorbing and bonding moisture in an amount that is a multiple of its own weight. The superabsorbent material has moreover the advantage that the absorbed moisture in the superabsorbent material will not freeze even at low temperatures and therefore a release in the form of gas molecules into the air stream is possible even under frost conditions. As a superabsorbent material, for example, a superabsorbent polymer (SAP) is conceivable which is constructed of hydrophilic polymer fibers which can absorb water and will swell in doing so. With the absorption of the water, a reversible absorption of the material takes place so that the water is embedded. Upon desorption the water is released again. The hydrophilic fibers can optionally be embedded in a nonwoven support. Instead of the hydrophilic polymer fibers, polymer beads may be used also.

According to a further expedient embodiment, the humidifier is positioned in the inlet air flow path upstream or downstream of the moisture exchanger. The inlet air flow path comprises the path section upstream of the moisture exchanger through which the fresh air is supplied to the membrane as well as the path section downstream of the moisture exchanger by means of which the fresh air enriched with moisture is guided to its intended use, for example, guided to the fuel cell. The position of the moisture reservoir can basically be located upstream or downstream of the moisture exchanger in the inlet air flow path. Preferably, the moisture reservoir is however arranged downstream of the moisture exchanger. The moisture exchanger and the moisture reservoir can be received in a common housing or in separate housings.

Possible in principle is also an arrangement of the moisture reservoir in the exhaust air flow path, in particular upstream of the moisture exchanger in order to enrich initially the exhaust air with moisture before the moisture is transferred by means of the moisture exchanger onto the inlet air in the inlet air flow path.

According to a further expedient embodiment, the moisture reservoir has a moisture storage medium that is at least section-wise connectable to or disconnectable from the flow path of the moisture exchanger. This provides the possibility to regenerate the moisture storage medium from time to time, i.e., to recharge it with moisture, which subsequently can then be released again into the inlet air in the flow path. This can be realized, for example, in that the moisture storage medium is adjustably arranged in the moisture reservoir so that, alternatively, different sections of the moisture storage medium project into the flow path of the moisture exchanger. It is in particular possible that a first section of the storage medium projects into the moisture-laden exhaust air flow path and a second section of the moisture medium is located at the same time in the dry inlet air flow path so that the first section is recharged with moisture and the second section releases moisture. After lapse of a defined time span or upon reaching a different switching criterion the section of the storage medium within the exhaust air flow path can be brought into the inlet air flow path so that the section that is now freshly recharged with moisture is in the dry inlet air flow path and can release its moisture. Expediently, the sections change their position so that the section that has been arranged previously in the inlet air flow path is now positioned in the exhaust air flow path and regenerates therein, i.e., can be recharged with moisture.

This embodiment can be realized, for example, by means of a moisture storage medium on a circulating conveyor belt which extends through the inlet air flow path as well as the exhaust air flow path wherein different sections of the storage medium by means of transport on the conveyor belt are moved into the desired position in the inlet air flow path or exhaust air flow path.

According to a further embodiment, two different moisture storage media are provided which can be brought alternatively into the flow path of the moisture exchanger. The two moisture storage media are located either in a common moisture reservoir or in two separate moisture reservoirs wherein the storage media by means of a suitable circuit configuration with switchable valves can be brought into the desired flow path, respectively. This embodiment has the advantage that the storage media themselves must not be adjusted; instead by means of switching of switchable valves the respective storage medium is connected to one or the other flow path to the moisture exchanger.

According to a further expedient embodiment, a bypass with a switching valve which bypasses the moisture reservoir is arranged in the flow path of the moisture exchanger. By means of the switching valve it is possible to activate either the flow path through the moisture reservoir or the flow path through the bypass so that the moisture reservoir is bypassed and flow through the moisture storage medium is prevented. Depending on the moisture level of the fresh air in the inlet air flow path, either a flow course through the bypass or through the moisture reservoir can be selected.

Adjustment of the air moisture in the inlet air flow path can be done actively as well as passively. For an active regulation at least one actuator is activated in the humidifier for switching between two different operating states. In case of a passive embodiment such an actuator is not required, humidification is realized by means of the permanently connected moisture reservoir.

Active humidifiers can be embodied either in regulated or in unregulated or controlled fashion. In case of a regulated embodiment, air moisture or another characteristic value is detected by a sensor and, in a control unit or controller, actuating signals for adjustment of at least one actuator are generated, for example, for switching a switching valve. In case of an unregulated or controlled embodiment, sensors are in principle not needed; the adjustment of an active actuator is realized by actuating signals of a control unit or controller according to predetermined criteria, for example, a fixedly set temporal rhythm.

### BRIEF DESCRIPTION OF THE DRAWINGS

Further advantages and expedient embodiments can be taken from the additional claims, the figure description, and the drawings. It is shown in:

FIG. 1 in schematic illustration a humidifier for a fuel cell, comprising a moisture exchanger that contains a water vapor-permeable membrane that is subjected crosswise to an inflowing inlet air stream and an inflowing exhaust air stream;

FIG. 2 a humidifier for a fuel cell, comprising a moisture exchanger and a moisture reservoir;

FIG. 3 a moisture reservoir with the storage medium on a transport belt;

FIG. 4 a humidifier for a fuel cell in a further embodiment, comprising two separately configured selectively connectable units, each comprised of a moisture exchanger and a moisture reservoir;

FIG. 5 in a further embodiment variant a humidifier with two units that are connectable and disconnectable by switching valves, each having a moisture exchanger and a moisture reservoir;

FIG. 6 an illustration in accordance with FIG. 5 but with a different circuit configuration of the exchanger-reservoir units.

In the figures same components are identified with same reference characters.

### EMBODIMENT(S) OF THE INVENTION

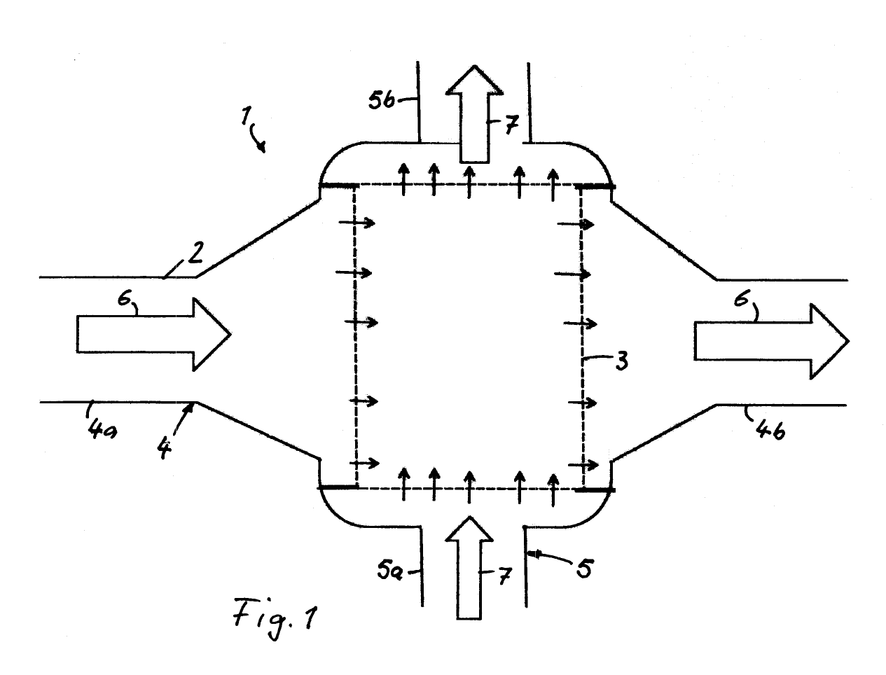

Through the humidifier 1 schematically illustrated in FIG. 1 fresh air that is enriched with moisture and has a minimum moisture contents is supplied to a fuel cell. The humidifier 1 comprises a cartridge 3 which is received exchangeably in a housing 2 and which transfers moisture contained in an exhaust gas stream onto a dry fresh air stream which is supplied to the fuel cell. The cartridge 3 has at least one, preferably several, stacked water vapor-permeable membranes.

Through a fresh air passage 4 in the housing 2 the humidifier 1 is supplied with ambient air as fresh air. The fresh air passage 4 has a supply section 4a upstream of the cartridge 3 as well as a discharge section 4b downstream of the cartridge.

In the housing 2, at a 90 degree angle to the fresh air passage 4 an exhaust gas passage 5 is extending by means of which exhaust gases of the fuel cell which are enriched with moisture are passed through the cartridge. The exhaust gas passage 5 has a supply section 5a upstream of the cartridge 3 and a discharge section 5b downstream of the cartridge.

Via the fresh air passage 4 a fresh air stream 6 is passed through the humidifier 1, by means of the crossing exhaust gas passage 5 the exhaust gas stream 7 which originates from the fuel cell. The crossing streams 6 and 7 are separated within the cartridge 3 by the water vapor-permeable membrane which enables only water exchange from the exhaust gas stream 7, laden with high moisture, onto the dry fresh air stream 6. The fresh air passage 4 forms the inlet air flow path for supply of fresh air enriched with moisture to the fuel cell, the exhaust gas passage 5 the exhaust air flow path.

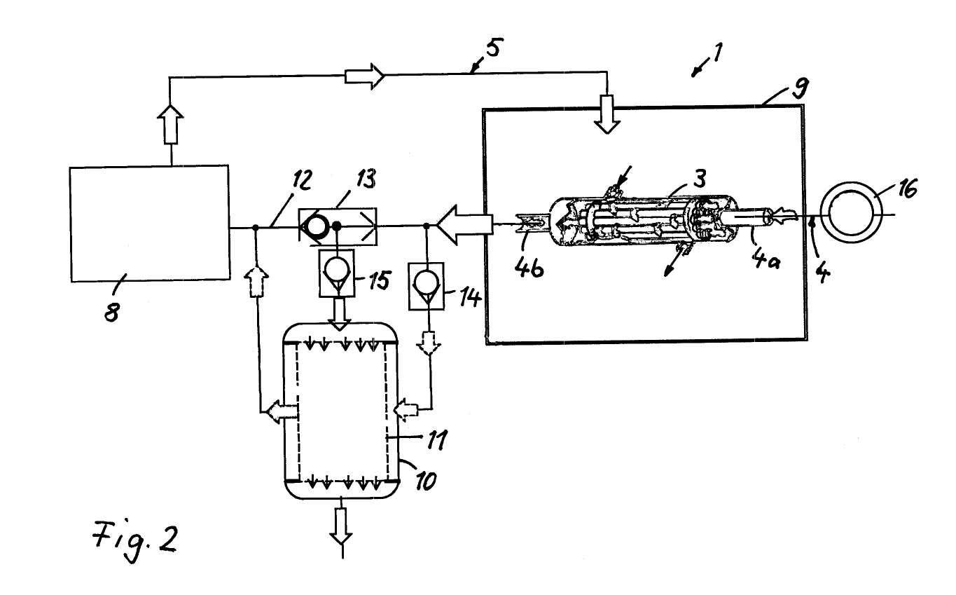

In FIG. 2, a humidifier 1 for a fuel cell 8 is illustrated. The humidifier 1 comprises a moisture exchanger 9 that serves to enrich the inlet air flow path 4 to the fuel cell 8 with moisture originating from the exhaust air flow path 5 which transports exhaust gas away from the fuel cell 8. The humidifier 1 comprises moreover a moisture reservoir 10 in which a moisture storage medium 11 is received, preferably a superabsorbent element or superabsorbent polymer (SAP). The moisture exchanger 9 and the moisture reservoir 10 that together form the humidifier 1 are arranged to be spatially separate from each other and are positioned in the inlet air flow path 4 behind each other. Optionally, the two units can also be arranged in a common housing. The moisture reservoir 10 is arranged downstream of the moisture exchanger 1 in the inlet air flow path 4.

In the moisture exchanger 9 the cartridge 3 with one or several membranes for water exchanger is arranged. The membranes are provided, for example, as hollow fibers which are flowed through axially in longitudinal direction by dry fresh air via the inlet air flow path 4 and which, in transverse direction, are subjected to inflow of the moisture-laden exhaust air of the fuel cell 8 in the exhaust air flow path 5. The moisture of the exhaust air is transferred by the membrane onto the fresh air stream. After moisture exchange, the exhaust air is discharged from the moisture exchanger 9 into the environment.

In the inlet air flow path 4, between the moisture exchanger 9 and the fuel cell 8, there is a bypass with a bypass line 12 and a switching valve 13 arranged therein. The bypass line 12 bypasses the moisture reservoir 10 so that in certain operating states the moisture reservoir 10 can be bypassed. Moreover, in a branch line which is extending through the moisture reservoir 10 and extends farther to the cathode side of the fuel cell 8, an adjustable switching valve 14 is arranged. A further switching valve 15 is arranged between the switching valve 13 and the moisture reservoir 10. With the bypass line 12 and the different switching valves 13 to 15, different operating modes in different operating states can be realized.

During the start phase, in particular at low temperatures, the moisture contents in the exhaust air of the fuel cell 8 that is passed via the exhaust air flow path 5 to the moisture exchanger 9 is insufficient. In order to provide at the cathode of the fuel cell 8 a sufficient moisture contents in the supplied fresh air stream, in the start phase of the fuel cell the cathode air stream is partially or completely passed through the moisture reservoir 10 with the moisture storage medium 11. For this purpose, the switching valve 14 is opened, the switching valve 13 is closed in the flow direction to the fuel cell 8. Inasmuch as a partial air stream is to be passed also immediately through the bypass line 12, the switching valve 13 can be moved into a partially open position.

In the normal operating state of the fuel cell 8 that follows the start phase, at the exhaust air side a sufficient moisture contents is available that passes through the exhaust air flow path 5 to the moisture exchanger 9 and is transferred thereat to the inlet air flow path 4. As a result of the higher moisture contents in the inlet air, the moisture reservoir 10 can be bypassed so that the inlet air to the cathode is supplied immediately via the bypass line 12. The switching valve 14 is moved into the closed position, the switching valve 13 is opened. The switching valve 15, which is arranged between the bypass line 12 and immediately the moisture reservoir 10, is in the closed position.

In order to discharge the moisture from the moisture exchanger 9 after switching off the fuel cell 8, the inlet air stream is guided to the exterior via the inlet air flow path 4 after switching off. Upstream of the moisture exchanger 9 in the inlet air flow path 4 a pressure source 16 is provided which pressurizes the inlet air in the flow path 4. In this way, even after switching off the fuel cell 8, it is ensured that a flow in the inlet air flow path 4 is generated and the still existing residual moisture in the moisture exchanger 9 can be passed via the open switching valve 13 and the switching valve 15 that is also open through the moisture reservoir 10 and subsequently discharged to the exterior. In the moisture reservoir 10 the residual moisture contained in the inlet air stream is stored in the moisture storage medium 11 which is regenerated and therefore charged again with moisture in this way. The switching valve 14 can remain closed in this operating phase.

The pressure source 16 which is, for example, a pump or a turbocharger can optionally also be switched on in the start phase and in the regular operating phase in order to ensure an air stream in the direction of the cathode of the fuel cell 8.

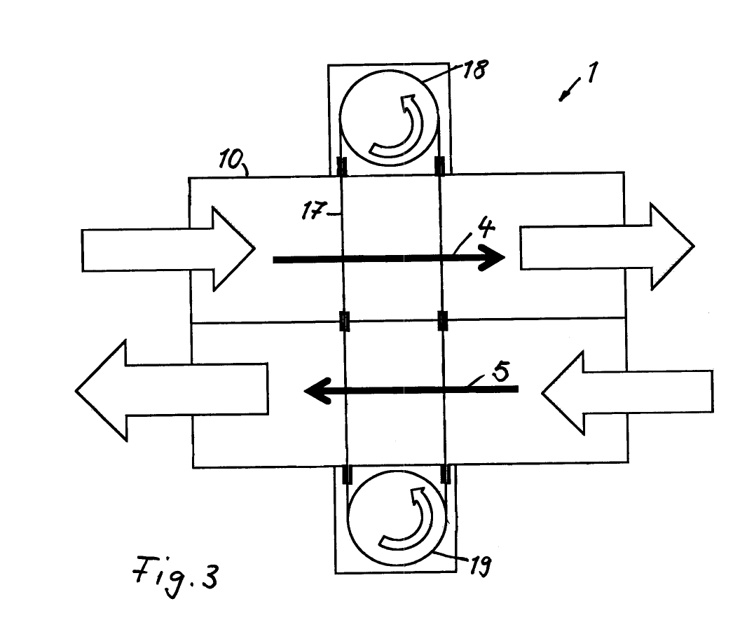

In the embodiment according to FIG. 3, a moisture reservoir 10 of a humidifier 1 is illustrated whose storage medium, as a superabsorbent polymer, is in the form of a coating on a circulating conveyor belt 17. The conveyor belt 17 is guided about two rollers 18, 19 and extends transversely to the flow direction of the inlet air flow path 4 or the exhaust air flow path 5. The two flow paths 4, 5 extend in opposite directions and through different stacked sections of the conveyor belt 17.

The embodiment according to FIG. 3 enables contact of different sections of the storage medium on the conveyor belt 17 with the inlet air flow path 4 or the exhaust air flow path 5. This makes it possible to keep a section of the storage medium that is laden with moisture within the air inlet flow path 4 and, at the same time, the section of the storage medium located within the exhaust air flow path 5 can be charged with moisture. After completion of the charging process, the position can be changed so that now a section of the storage medium which is laden with moisture is within the inlet air flow path 4 and a further section of the storage medium that is to be charged is positioned within the exhaust air flow path 5. The change of the different sections of the storage medium between the inlet air flow path 4 and the exhaust air flow path 5 is either done in a regulated fashion in that the moisture is determined by a sensor or in a controlled fashion in that, for example, after lapse of a defined time span, the conveyor belt 17 is adjusted by actuating an actuator.

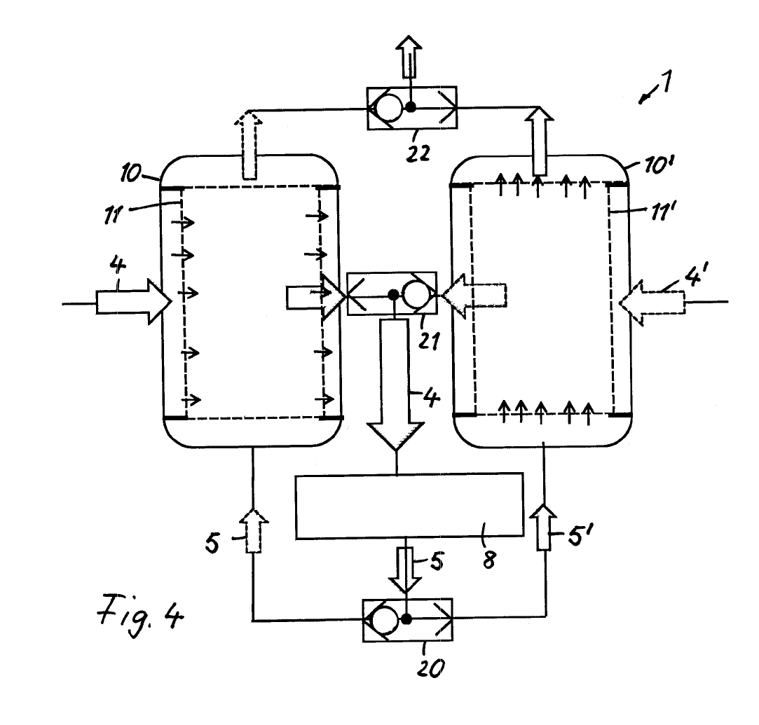

In FIG. 4 an embodiment with two separately controllable moisture reservoirs 10 and 10′ is illustrated. The moisture reservoirs each have expediently also a moisture exchanger correlated therewith. The two moisture reservoirs 10 are flowed through alternatingly by the exhaust gas stream of the fuel cell 8 in order to charge the respective storage medium 11 or 11′ with moisture for regeneration. The other moisture reservoir is connected to the inlet air flow path so that the air to be supplied to the cathode of the fuel cell is passed across this moisture reservoir and is enriched with moisture.

The two moisture reservoirs 10, 10′ are arranged parallel and can be connected each to the inlet air flow path 4 and 4′ as well as to the exhaust air flow path 5 or 5′. Switching is done by means of switching valves 20 to 22. A first switching valve 20 is immediately downstream of the fuel cell 8 in the exhaust air flow path 5 and switches the exhaust air between the two moisture reservoirs 10 and 10′. When, for example, the second moisture reservoir 10′ is to be charged with moisture, the switching valve 20 is adjusted as illustrated so that the exhaust air stream 5′ is passed through the moisture reservoir 10′ and the storage medium 11′ is charged with moisture. Downstream of the moisture reservoir 10′, the dried exhaust gas stream is then discharged through switching valve 22 into the environment. At the same time, at the intake side the inlet air flow path 4 through the first moisture reservoir 10 is open so that the supplied fresh air can be enriched with moisture and through the open switching valve 21 is supplied to the cathode of the fuel cell 8.

When on the other hand the storage medium 11 in the first moisture reservoir 10 is to be regenerated with moisture, i.e., charged, the switching valves are adjusted accordingly so that the exhaust air stream is passed through the first moisture reservoir 10 and the supplied fresh air according to flow path 4′ is guided through the second moisture reservoir 10′.

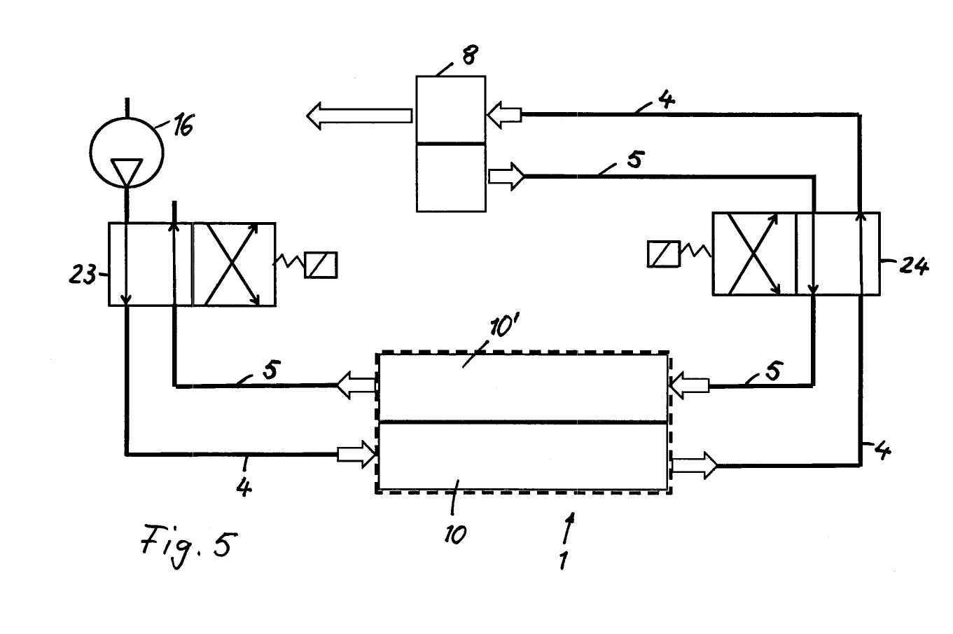

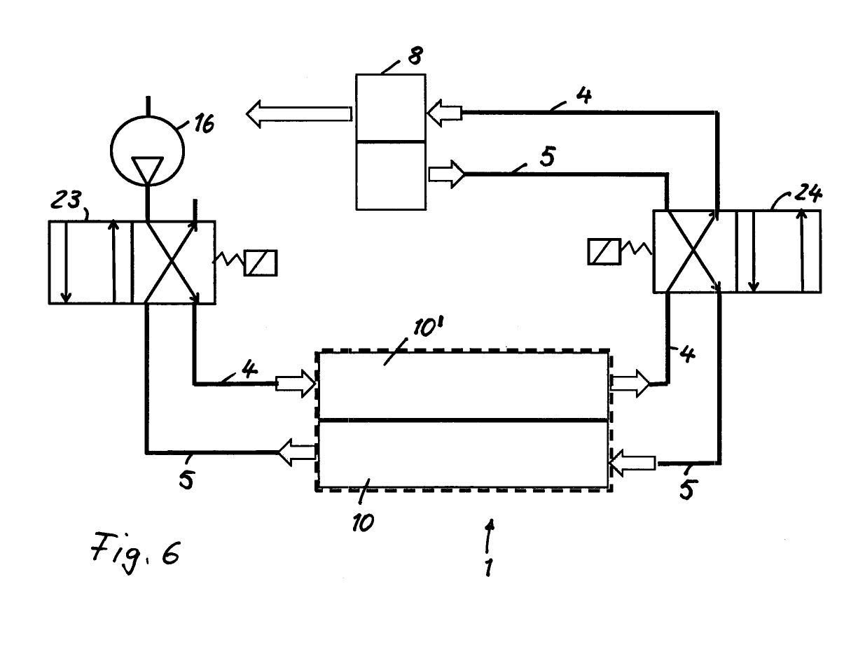

In FIGS. 5 and 6 a further embodiment is illustrated in which the humidifier 1 has two different moisture reservoirs 10 and 10′ that are connected by switching valves 23, 24 such to the inlet air or exhaust air that alternatingly moisture is released into the inlet air or moisture is absorbed from the exhaust air stream. In FIG. 5 the inlet air flow path 4 with fresh air which is driven by the pressure source 16 is passed by an appropriate switching of the switching valve 23 to the first moisture reservoir 10 and the fresh air charged with moisture is supplied downstream to the cathode of the fuel cell 8. The exhaust air of the fuel cell 8 is supplied by appropriate switching of the second switching valve 24 in the exhaust air flow path 5 to the second moisture reservoir 10 in which the storage medium is charged with moisture.

In FIG. 6 the switching valves 23, 24 are moved into a different switching position so that the moisture reservoirs 10, 10′ are operated in reverse mode. The fresh air is supplied through the inlet air supply flow path 4 to the second moisture reservoir 10′, the exhaust air of the fuel cell 8 on the other hand is supplied via the exhaust air flow path 5 to the first moisture reservoir 10.

1-10. (canceled)

11. A humidifier comprising:
a moisture exchanger with at least one water-permeable or water vapor-permeable membrane that separates an inlet air flow path of the humidifier from an exhaust air flow path of the humidifier;
a moisture reservoir positioned in a flow path of the moisture exchanger.

12. The humidifier according to claim 11, wherein
the moisture reservoir comprises
a superabsorbent material as a moisture storage medium.

13. The humidifier according to claim 11, wherein
the moisture reservoir is positioned within the inlet air flow path.

14. The humidifier according to claim 11, wherein
the moisture reservoir is connected to the moisture exchanger downstream of the moisture exchanger in a flow direction of the flow path.

15. The humidifier according to claim 11, wherein
the moisture reservoir contains a moisture storage medium and
wherein the moisture storage medium is arranged such that sections of the moisture storage medium are connectable to and disconnectable from the flow path of the moisture exchanger.

16. The humidifier according to claim 15, wherein
the moisture storage medium is adjustably arranged in the moisture reservoir so that, alternatively, different sections of the moisture storage medium can be introduced into the flow path of the moisture exchanger.

17. The humidifier according to claim 11, further comprising
a bypass provided with a switching valve;
wherein the bypass is arranged in the flow path of the moisture exchanger and bypasses the moisture reservoir.

18. The humidifier according to claim 11, comprising
two of said moisture reservoir connectable alternatively to the flow path of the moisture exchanger.

19. The humidifier according to claim 18, wherein
moisture of air passing through the humidifier is determined by a sensor and is adjustable to a nominal value.

20. A fuel cell with a humidifier according to claim 11.
